(19) United States
(12) Patent Application Publication
(10) Pub. No.: US 2024/0263977 A1
(43) Pub. Date: Aug. 8, 2024

(54) SENSOR DEVICE WITH AN ATTACHABLE AND DETACHABLE COMPONENT

(71) Applicant: HONEYWELL INTERNATIONAL INC., Charlotte, NC (US)

(72) Inventors: Basavaprashant DUMPALA, Charlotte, NC (US); Kumaran S. NARASIMHAN, Charlotte, NC (US); Gurudutt K. K, Charlotte, NC (US); Shivaraj ARAKERI, Charlotte, NC (US); Ronald W. MYERS, Charlotte, NC (US)

(21) Appl. No.: 18/421,404

(22) Filed: Jan. 24, 2024

(30) Foreign Application Priority Data
Feb. 7, 2023 (IN) 202311007784

(51) Int. Cl. G01D 21/00

(52) U.S. Cl. CPC G01D 21/00

(57) ABSTRACT

A sensor is disclosed herein. In an example sensor may include a first component including a sensing element, a first power connector, a first ground connector, and a signal connector. The sensor may include a second component including a receiving circuitry, a second power connector, a second ground connector, and a second signal connector. The first and second components may be configured to attach to and detach from each other. Any of the first and second power connectors, the first and second ground connectors, and the first and second signal connectors may be configured such that when the first and second components are attached to each other the first and second power and the first and second ground connectors are electronically coupled before the first and second signal connectors.

### CROSS-REFERENCE TO RELATED APPLICATIONS

This application claims priority pursuant to 35 U.S.C. 119(a) to Indian application Ser. No. 20/231,1007784, filed Feb. 7, 2023, which application is incorporated herein by reference in its entirety.

### BACKGROUND

Sensors may be used to sense various parameters in an environment. For example, sensors may sense temperature, pressure, flow rate, presence of various matters or energy, etc. Some components of a sensor may need replacement. Replacing a component of a sensor may be cumbersome and/or costly. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to methods, apparatuses, and systems for assembling, attaching, detaching, and/or using a sensor device.

Various embodiments herein provide a sensor device. The sensor device may comprise a first component comprising a sensing element, a first power connector and a first ground connector configured to provide power to the sensing element, and one or more first signal connectors configured to transmit sensing signal from the sensing element. The sensor device may comprise a second component comprising a receiving circuitry configured to receive the sensing signal, a second power connector and a second ground connector configured to electronically couple to the first power connector and the first ground connector respectively, and one or more second signal connectors configured to electronically couple to the corresponding one or more first signal connectors to transmit the sensing signal to the receiving circuitry. In various embodiments, the first component is configured to attach to the second component, wherein when attaching the first component to the second component the first power connector electronically couples to the second power connector and the first ground connector electronically couples to the first ground connector before any of the one or more first signal connectors electronically couple to the corresponding one or more second signal connectors.

In various embodiments, the first component is configured to attach to the second component by a twist motion and wherein the first power connector electronically couples to the second power connector, the first ground connector electronically couples to the second ground connector, and the one or more first signal connectors electronically couple to the corresponding one or more second signal connectors during the twist motion.

In various embodiment, the first component is configured to attach to the second component by an insertion and a twist motion, wherein the first power connector electronically couples to the second power connector or the first ground connector electronically couples to the second ground connector during the insertion, and the one or more first signal connectors electronically couple to the corresponding one or more second signal connectors during the twist motion.

In various embodiments, the first component is configured to attach to the second component by an insertion and a twist motion, wherein the first power connector electronically couples to the second power connector, the first ground connector electronically couples to the second ground connector, and the one or more first signal connectors electronically couples to the corresponding one or more second signal connectors during the insertion.

In various embodiments, the first and second power connectors are configured to provide power from the second component to the sensing element and the one or more first and second signal connectors are configured to transmit the sensing signal from the sensing element to the receiving circuitry.

In various embodiments, the first and second power connectors comprise first and second circular power bands or the first and second ground connectors comprise first and second circular ground bands.

In various embodiments, the first component comprises one or more tabs and the second components comprise one or more notches, wherein the one or more tabs and one or more notches are configured to guide the first component to be inserted into the second component.

In various embodiments, the one or more tabs and the one or more notches are placed to prevent the one or more first signal connectors from electronically coupling to the corresponding one or more second signal connectors before the first and second power connectors are electronically coupled and the first and second ground connectors are electronically coupled.

In various embodiments, the first component is configured to attach to the second component using a twist motion, wherein the first component comprises one or more depressions and the second components comprise one or more protrusions, wherein the one or more protrusions and the one or more depressions are configured to lock the first component into the second component at an end of the twist motion.

In various embodiments, the first component is configured to attach to the second component using a twist motion and detach from the second component using a reverse twist motion. In various embodiments, the first component is configured to attach to the second component using a sliding motion and detach from the second component using a reverse sliding motion.

In various embodiments, a first subset of the one or more first signal connectors electronically couple to a second subset of the one or more second signal connectors before a rest of the one or more first signal connectors electronically couple to a rest of the one or more second signal connectors.

Various embodiments herein provide a method for assembling a sensor, the method comprising attaching a first component of the sensor to a second component of the sensor, and electronically coupling a first power connector to a second power connector and a first ground connector to a second ground connector before electronically coupling one or more first signal connectors to one or more second signal connectors. In various embodiments, the first power connector, the first ground connector, and the one or more first signal connectors are disposed on the first component and the second power connector, the second ground connector, and the one or more second signal connectors are disposed on a second component.

In various embodiments, the method comprises attaching the first component of the sensor to the second component of the sensor by a twist motion, and electronically coupling the first power connector to the second power connector, the first ground connector to the second ground connector, and the one or more first signal connectors to the one or more second signal connectors during the twist motion.

In various embodiments, the method comprises attaching the first component of the sensor to the second component of the sensor by an insertion and a twist motion, electronically coupling the first power connector to the second power connector or the first ground connector to the second ground connector during the insertion, and electronically coupling the one or more first signal connectors to the one or more second signal connectors during the twist motion.

In various embodiments, the method comprises enabling a power transmission from the second component to a sensing element disposed on the first component via the first and second power and ground connectors and enabling a signal transmission from the sensing element to a receiving circuitry disposed on the second component via the one or more first and second signal connectors.

In various embodiments, the method comprises attaching the first component of the sensor to the second component of the sensor by a twist motion and sliding the first power connector on the second power connector, the first ground connector on the second ground connector, or the one or more first signal connectors over the one or more second signal connectors during the twist motion.

In various embodiments, the method comprises attaching the first component of the sensor to the second component of the sensor by an insertion and guiding the first and second components during the insertion using one or more tabs on the first component and one or more notches on the second component.

In various embodiments, the method comprises attaching the first component of the sensor to the second component of the sensor by the insertion and a twist motion and locking the first and second components at an end of the twist motion using one or more depressions on the first component and one or more protrusions on the second component.

In various embodiments, the method comprises attaching the first component of the sensor to the second component of the sensor by a sliding motion and detaching the first component of the sensor from the second component of the sensor by a reverse sliding motion.

In various embodiments, the method comprises electronically coupling a first subset of the one or more first signal connectors to a second subset of the one or more second signal connectors before electronically coupling a rest of the one or more first signal connectors to a rest of the one or more second signal connectors.

Various embodiments herein provide a sensor comprising a first component comprising a sensing element, a first power connector, a first ground connector, and one or more first signal connectors, a second component comprising a receiving circuitry, a second power connector, a second ground connector, and one or more second signal connectors, wherein the first and second components are configured to attach to and detach from each other and any of the first and second power connectors, the first and second ground connectors, and the one or more first and second signal connectors are configured such that when the first and second components are attached to each other the first and second power and the first and second ground connectors are electronically coupled before the one or more first and second signal connectors.

In various embodiments, the sensing element is configured to power on when the first and second power connectors are electronically coupled to each other and the first and second ground connectors are electronically coupled to each other.

In various embodiments, the one or more first and second signal connectors are configured to transmit sensing signal from the sensing element to the receiving circuitry when the one or more first and second signal connectors are electronically coupled to each other.

In various embodiments, the first component is configured to attach to the second component using any of an insertion, twist, and/or sliding motion and detach from the second component using any of a reverse insertion, twist, and/or sliding motion.

In various embodiments, a first subset of the one or more first signal connectors electronically couple to a second subset of the one or more second signal connectors before a rest of the one or more first signal connectors electronically couple to a rest of the one or more second signal connectors.

Various embodiments herein provide a sensor comprising a first component comprising a sensing element, a first power connector, a first ground connector, and one or more first signal connectors; and a second component comprising: a receiving circuitry; and a second power connector, a second ground connector, and one or more second signal connectors arranged on a surface of the second component, wherein a shape of the surface of the second component comprises a curved contour and is configured to flatten when the first component attaches to the second component so that the first and second ground connectors, the first and second power connectors and the one or more first and second signal connectors are electronically coupled respectively.

In various embodiments, the surface of the second component comprises a flexible material. In various embodiments, the curved contour comprises a camber profile. In various embodiments, the curved contour shape of the surface of the second component is configured to remove all or some of fluid from the surface of the second component.

In various embodiments, the first component is configured to attach to the second component using a twist motion, wherein the first component comprises one or more depressions and the second components comprise one or more protrusions, wherein the one or more protrusions and the one or more depressions are configured to lock the first component into the second component at an end of the twist motion.

In various embodiments, the sensor further comprising a visual guide configured to guide aligning the first and second components for attachment. In various embodiments, the sensor further comprises a first visual indicator configured to indicate that that the one or more first and second signal connectors are electronically coupled respectively; and a second visual indicator configured to indicate that the first and second ground connectors and the first and second power connectors are electronically coupled respectively.

In various embodiments, the surface of the second component comprises a hydrophobic material. In various embodiments, a water contact angle of the hydrophobic material is greater than approximately 150°.

In various embodiments, the surface of the second component comprises a textured pattern configured to remove all or some of fluid from the surface of the second component by guiding the fluid off the surface of the second component. In various embodiments, the surface of the second component comprises a lubricant material.

In various embodiments, the textured pattern comprises one or more elongated parallel grooves configured to move the fluid off the surface of the second component. In various embodiments, the textured pattern comprises one or more elongated intersecting grooves configured to move the fluid off the surface of the second component.

Various embodiments herein provide a sensor comprising a first component comprising a sensing element, a first power connector, a first ground connector, and one or more first signal connectors; and a second component comprising: a receiving circuitry; and a second power connector, a second ground connector, and one or more second signal connectors arranged on a surface of the second component, wherein the surface of the second component comprises a textured pattern configured to guide all or some of fluid away from the second power connector, the second ground connector, or the one or more second signal connectors arranged on the surface of the second component.

In various embodiments, the surface of the second component comprises a lubricant in the textured pattern. In various embodiments, the surface of the second component comprises a hydrophobic material in the textured pattern. In various embodiments, a water contact angle of the hydrophobic material is greater than approximately 150°.

In various embodiments, the textured pattern comprises one or more elongated parallel grooves configured to move the fluid away from the second power connector, the second ground connector, or the one or more second signal connectors arranged on the surface of the second component.

In various embodiments, the textured pattern comprises one or more elongated intersecting grooves configured to move the fluid away from the second power connector, the second ground connector, or the one or more second signal connectors arranged on the surface of the second component

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1(A) illustrates an example schematic diagram depicting a sensor in accordance with various embodiments of the present disclosure;

FIG. 1(B) illustrates an example schematic diagram depicting a sensor in accordance with various embodiments of the present disclosure;

FIG. 2(A) illustrates an example schematic diagram depicting various connectors of a sensor in accordance with various embodiments of the present disclosure;

FIG. 2(B) illustrates an example schematic diagram depicting various connectors of a sensor in accordance with various embodiments of the present disclosure;

FIG. 2(C) illustrates an example schematic diagram depicting various connectors of a sensor in accordance with various embodiments of the present disclosure;

FIG. 3 illustrates an example schematic diagram depicting various connectors of a sensor in accordance with various embodiments of the present disclosure;

FIG. 4(A) illustrates an example schematic diagram depicting various signal connectors of a sensor in accordance with various embodiments of the present disclosure;

FIG. 4(B) illustrates an example schematic diagram depicting various signal connectors of a sensor in accordance with various embodiments of the present disclosure;

FIG. 5 illustrates an example schematic diagram depicting various connectors of a sensor in accordance with various embodiments of the present disclosure;

FIG. 6 illustrates an example schematic diagram depicting various connectors of a sensor in accordance with various embodiments of the present disclosure;

FIG. 7 illustrates an example schematic diagram depicting various connectors of a sensor in accordance with various embodiments of the present disclosure;

FIG. 8 illustrates an example schematic diagram depicting a sensor in accordance with various embodiments of the present disclosure;

FIG. 9 illustrates an example schematic diagram depicting a sensor in accordance with various embodiments of the present disclosure;

FIG. 10 illustrates an example schematic diagram depicting a sensor in accordance with various embodiments of the present disclosure;

FIG. 11 illustrates an example schematic diagram depicting a dialysis system in accordance with various embodiments of the present disclosure;

FIG. 12 illustrates an example schematic diagram depicting a controller in accordance with various embodiments of the present disclosure;

FIG. 13 is a flowchart diagram illustrating example operations in accordance with various embodiments of the present disclosure;

FIG. 14 is a flowchart diagram illustrating example operations in accordance with various embodiments of the present disclosure;

FIG. 15 is a flowchart diagram illustrating example operations in accordance with various embodiments of the present disclosure;

FIG. 16 is a schematic diagram illustrating a sensor in accordance with various embodiments of the present disclosure;

FIG. 17(A) is a schematic diagram illustrating a sensor in accordance with various embodiments of the present disclosure;

FIG. 17(B) is a schematic diagram illustrating various components of a sensor in accordance with various embodiments of the present disclosure;

FIG. 17(C) is a schematic diagram illustrating various components of a sensor in accordance with various embodiments of the present disclosure;

FIG. 18(A) is a schematic diagram illustrating various components of a sensor in accordance with various embodiments of the present disclosure; and

FIG. 18(B) is a schematic diagram illustrating a surface in a sensor in accordance with various embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

The phrases “in an example embodiment,” “some embodiments,” “various embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such components or features may be optionally included in some embodiments, or may be excluded.

The terms “electronically coupled” or “in electronic communication with” in the present disclosure refer to two or more electrical elements (for example, but not limited to, a controller, a sensing element, a receiving circuitry, power connector(s), ground connector(s), signal connector(s), an example processing circuitry, communication module, input/output module, memory) and/or electric circuit(s) being connected through wired means (for example but not limited to, conductive wires or traces) and/or wireless means (for example but not limited to, wireless network, electromagnetic field), such that data and/or information (for example, data may be included in electronic indications, signals, etc.) may be transmitted to and/or received from the electrical elements and/or electric circuit(s) that are electronically coupled.

A sensor may determine various parameters from or related to the environment where it is placed. For example, a sensor may determine various parameters related to matter and/or energy present in the environment. For example, a sensor may determine parameters of or related to temperature, pressure, flow, velocity, movement, light, photons, electricity, waves, electromagnetic fields, magnetic fields, electrical fields, emissions, particles, dust, chemicals, material type, and/or presence or absence of materials or substances, etc. The sensor may include a sensing element that interacts with and/or senses the matter and/or energy or their related parameters in the environment and generates a sensing signal accordingly. The sensor may include a reading circuitry that receives the sensing signal from the sensing element.

A receiving circuitry may be configured to work with various types of sensing elements or with different sensing elements of the same type. For example, the receiving circuitry may receive sensing signal from one or more types of sensing elements configured to detect any of the parameters as for example described above.

In some examples, the sensing element may need to be replaced with another sensing element of the same or different type. For example, the sensing element may be disposable, and/or need to be replaced due to age, malfunction, sanitary reasons, etc.

In some examples, the receiving circuitry may be more costly than the sensing element. It may be desirable to replace the sensing element of the sensor without having to replace the receiving circuitry. Doing so may for example be more cost effective, environmentally friendly, quicker, and/or more convenient than replacing both the sensing element and the receiving circuitry. Various embodiments herein provide systems and/or methods to replace a sensing element of a sensor without the need to replace the receiving circuitry.

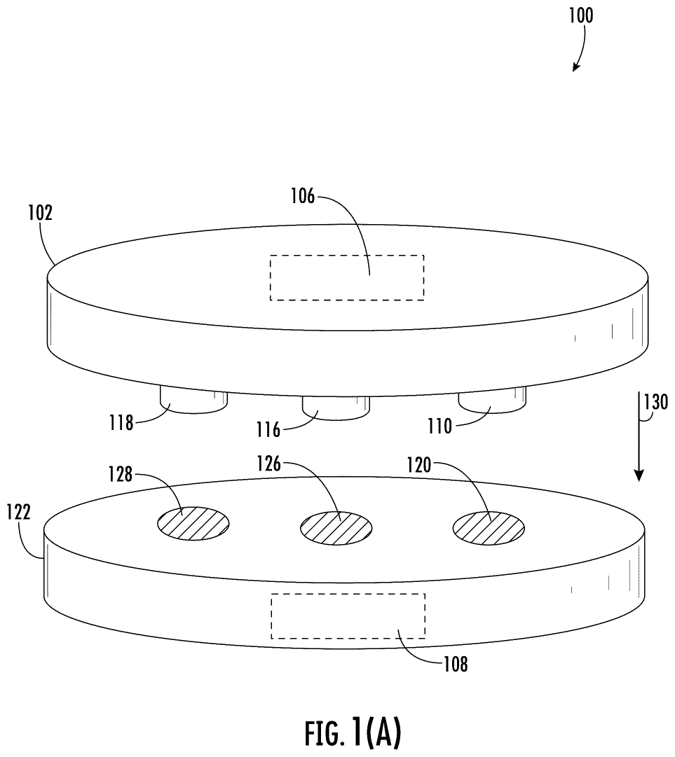

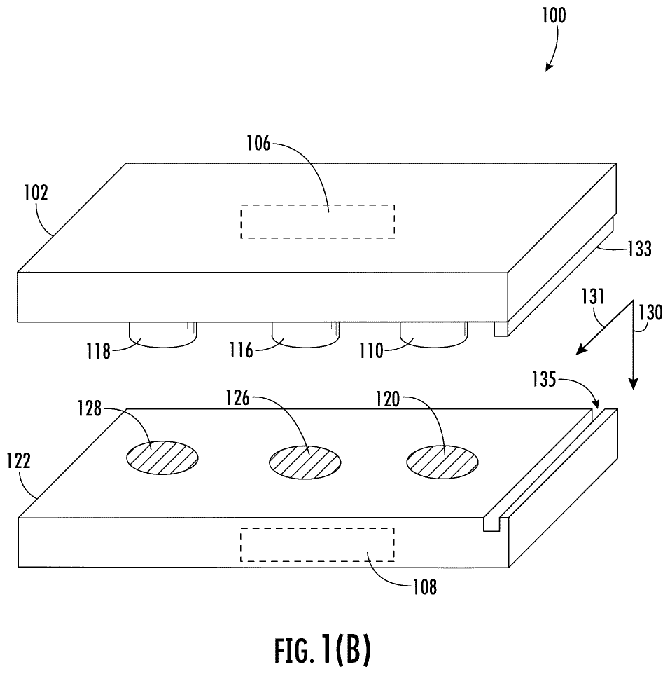

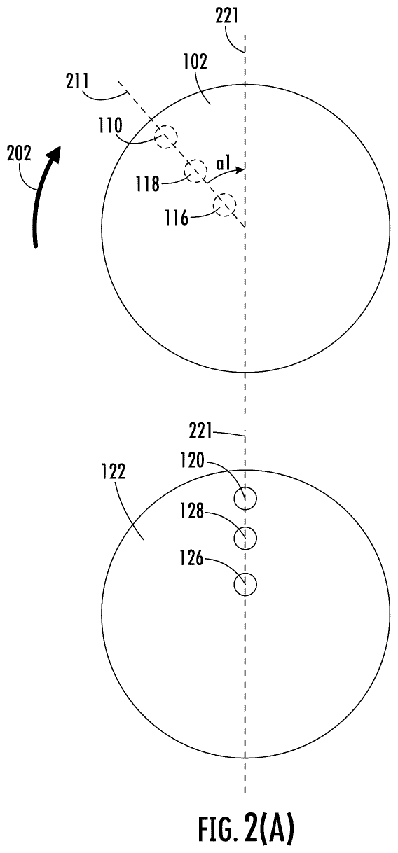

Referring now to FIG. 1(A), a schematic diagram illustrating a sensor 100 in accordance with various embodiments of the present disclosure is provided. In various embodiments, the sensor 100 includes a first component 102 and a second component 122. The first component 102 and the second component 122 may have various shapes such as circular, oval, square, rectangular, and/or any other geometrical shapes or combinations thereof. The shapes shown in various figures and descriptions herein are examples and for illustration purposes.

In various embodiments, the first component 102 may include a sensing element 106. The sensing element 106 may be configured to sense various parameters of or related to matter and/or energy present in the environment, as for example previously described, and generate a sensing signal accordingly. In example embodiments, the sensing element 106 is any of a flow sensing element, pressure sensing element, temperature sensing element, heat or fire sensing element, infrared sensing element, ultraviolet sensing element, light sensing element, chemical sensing element, dust sensing element, etc.

In various embodiments, the first component includes a first power connector 116 and a first ground connector 118. In example embodiments, the first power connector 116 and the first ground connector 118 may provide power to the sensing element 106 e.g., to power on the sensing element 106. In various embodiments, the first component 102 includes one or more first signal connectors 110. In example embodiments, the signal connectors are configured to transmit sensing signal from the sensing element 106.

In various embodiment, sensing data may be extracted from the sensing signal. In example embodiment, the sensing element 106 may generate sensing data. In example embodiments, the sensing element 106 may extract sensing data from the sensing signal. In example embodiment, an extracting circuitry (as part of the sensing element or as a different circuitry) may extract sensing data from sensing signal. In an example embodiment, the extracting circuitry is included in the first component 102. In example embodiments, the sensing data may be transmitted via the one or more signal connectors.

In various embodiment, the sensor 100 includes a second component 122. In various embodiments, the second component 122 may include a receiving circuitry 108. In example embodiments, the receiving circuitry 108 is configured to receive the sensing signal and/or data from the sensing element 106. In an example embodiment, the receiving circuitry is configured to extract the sensing data from the sensing signal received from the sensing component 106. In various embodiments, the second component 122 includes one or more second signal connectors 120 configured to electronically couple to the one or more first signal connectors 110 to transmit the sensing signal and/or data to the receiving circuitry. It is noted that the shapes and or cross section of the various connectors as shown in FIG. 1(A) are for illustrative purposes only and they can have any geometrical shapes or combinations thereof such as circular, oval, square, rectangular, etc.

In various embodiments, the second component 122 includes a second power connector 126 and a second ground connector 128. In example embodiments, the second power connector 126 and the second ground connector 128 are configured to electronically couple to the first power connector 116 and the first ground connector 118 respectively. In various embodiments a power supply is electronically coupled to the second power connector 126 and the second ground connector 128. In various embodiments, the power supply provides power to the sensing element 106 supply via the second power connector 126 and the second ground connector 128 when electronically coupled to the first power connector 116 and the first ground connector 118 respectively.

In various embodiments, the first component 102 may be configured to attach to and/or detach from the second component 122. For example, the first component 102 is a disposable and/or replaceable part of the sensor 100. In an example, the second component 122 is a base station component of the sensor 100. In example embodiments, the first component 102 may be moved towards the second component 122 in a direction 130 and attach to the second component 122.

In various embodiments, the first component 102 is configured to attach to the second component 122. In example embodiments, the first component 102 is configured to attach to the second component 122 by a twist motion. For example, the first component 102 is moved towards the second component 122 and is twisted e.g., clockwise or counterclockwise to attach to the second component 122. In various embodiments, the first component 102 is configured to detach from the second component 122. In example embodiments, the first component 102 is configured to detach from the second component 122 by a reverse twist motion. For example, if the first component 102 is attached to the second component 122 by a clockwise motion, it may be detached by a counterclockwise motion and vice versa.

In various embodiments, when the first component 102 attaches to the second component 122, the first power connector 116 electronically couples to the second power connector 126 and the first ground connector 118 electronically couples to the second ground connector 128 before the one or more first signal connectors 110 electronically couple to the one or more second signal connectors 120. It is noted that the positions of the power, ground, or signal connectors shown in the figures, for example in FIG. 1(A), are for illustration purposes and the connectors may have various other positions on the first or second components.

In various embodiments, by coupling the power and ground connectors first, power is provided to the sensing element 106 before signal connections are established. In example embodiments, powering the sensing element 106 before establishing signal connections to it protects the electronic components and/or a circuitry of the sensing element 106. For example, it protects the sending element 106 from harmful electrical surge, spikes, and/or shock.

In various embodiments, the first power connector 116 electronically couples to the second power connector, the first ground connector electronically couples to the second ground connector, and the one or more first signal connectors electronically couple to the one or more second signal connectors during the twist motion. In various embodiments, the power, ground, and signal connectors are arranged, shaped, and/or sized such that the first and second signal connectors are electronically coupled after the first and second power and ground connectors are coupled respectively, and power is provided to the sensing element 106.

In various embodiments, the first component 102 is configured to connect to the second component 122 using various motions other than and/or including a twist motion. In various embodiments, the first component 102 attaches to the second component 122 using motions including a linear and/or a non-linear sliding motion. In various embodiments, the first component 102 attaches to the second component 122 using motions including any of an insertion, a twist, and/or a linear and/or a non-linear sliding motion.

In various embodiments, the first component 102 detaches from the second component 122 using motions including a reverse linear and/or a reverse non-linear sliding motion. In various embodiments, the first component 102 detaches to the second component 122 using motions including any of a reverse insertion, a reverse twist, and/or a reverse linear and/or a reverse non-linear sliding motion. In various embodiments, when the first component 102 detaches from the second component 122, the one or more first signal connectors 110 electronically decouple from the one or more second signal connectors 120 before the first power connector 116 electronically decouples from the second power connector 126 and the first ground connector 118 electronically decouples from the second ground connector 128.

Referring to FIG. 1(B), a schematic diagram illustrating a sensor 100 in accordance with various embodiments of the present disclosure is provided. In various embodiments, the first component the first component 102 is attached to the second component using a sliding motion, for example in the direction 131. In various embodiments, the direction 131 is approximately parallel to a surface of the first component 102 and/or the second component 122.

In various embodiments, the first component 102 includes a lip 133 and the second component 122 includes a groove 135. In example embodiment, the lip 133 guides the first component 102 to slide over the second component 122. In various embodiments, the first component 102 includes one or more lips such as the lip 133 and the second component includes one or more grooves such as groove 135. In example embodiments the lips and grooves are configured to guide the first component 102 to slide over the second component 122. In example embodiment, the first component 102 is locked to the second component 122 at the end of the sliding motion.

In various embodiments, when the first component 102 attaches to the second component 122, for example using the sliding motion, the first power connector 116 electronically couples to the second power connector 126 and the first ground connector 118 electronically couples to the second ground connector 128 before the one or more first signal connectors 110 electronically couple to the one or more second signal connectors 120.

In various embodiment, the first component 102 detaches from the second component 122 using a reverse sliding motion for example in the reverse of the direction 131.

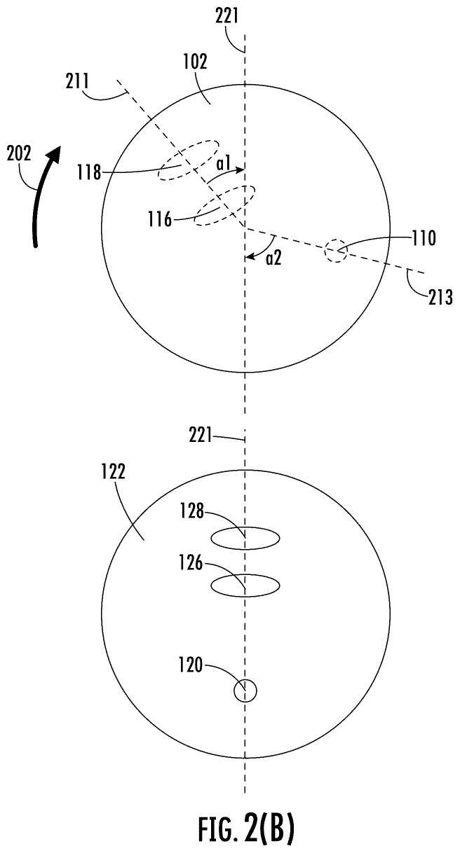

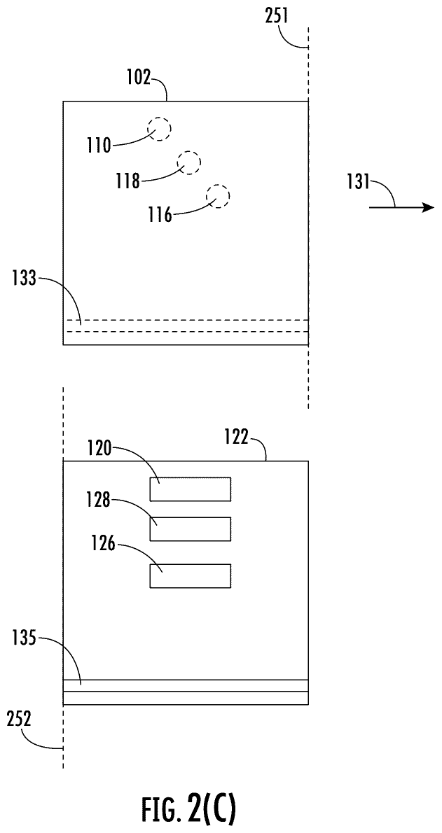

Referring to FIG. 2(A), a schematic diagram illustrating various connectors of a sensor 100 in accordance with example embodiments of the present disclosure is provided.

In various embodiments, the first power connector 116, the first ground connector 118, and the one or more first signal connectors 110 are placed radially on a first radial axis 211 on the first component 102 as for example shown in FIG. 2(A) from a top perspective. In various embodiments, the second power connector 126, the second ground connector 128, and the one or more second signal connectors 120 are placed radially on a second radial axis 221 on the second component 122. In various embodiments, the second radial axis 221 is offset with an angle a1 relative to the first radial axis 211.

In various embodiments, the first component 102 is move sufficiently close to the second component 122, and/or the first component 102 is inserted into the second component 122, and is twisted in a direction 202 at an angle a1. In various embodiments, during the twist motion, the connectors on the first component that are closer to the center are electronically coupled before the connectors that are further away from the center due to the lesser relative distance for the connectors that are closer to the center. For example, the first power connector 116 is placed on the first component 102 such that when the first component 102 is sufficiently moved towards the second component 122 and is twisted in a direction 202 and at an angle a1, first the first power connector 116 is electronically coupled to the second power connector 126, then the first ground connector 118 is electronically coupled to the second ground connector 128, and lastly the one or more first signal connectors 110 are electronically coupled to the one or more second signal connectors 120. It is noted that the direction 202 is clockwise in an example and in another example it may be counterclockwise.

In example embodiments, 10°≤a1≤180°. In example embodiments, 20°≤a1≤90°. In example embodiments, 30°≤a1≤90°. In example embodiments, 40°≤a1≤90°. In example embodiments, 60°≤a1≤90°. In example embodiments, 30°≤a1≤80°. In example embodiments, 30°≤a1≤70°. In example embodiments, 30°≤a1≤60°. In example embodiments, 30°≤a1≤50°. In example embodiments, a1 is about 20°. In example embodiments, a1 is about 30°. In example embodiments, a1 is about 40°. In example embodiments, a1 is about 50°. In example embodiments, a1 is about 60°. In example embodiments, a1 is about 70°. In example embodiments, a1 is about 80°. In example embodiments, a1 is about 90°.

Referring to FIG. 2(B), a schematic diagram illustrating various connectors of a sensor 100 in accordance with example embodiments of the present disclosure is provided. In various embodiments, the one or more first signal connector 110 are placed on a third radial axis 213 with a relative offset of a2 degrees from radial axis 221 in the direction 202 as for example shown in FIG. 2(B). In various embodiments, a2≥a1.

In various embodiments, the first power connector 116, the first ground connector 118, the second power connector 126 and the second ground connector 128 have elongated shapes such that as the first component is twisted in the direction 202, the first and second ground and power connectors electronically couple to each other respectively before the one or more first signal connectors 110 electronically couple to the one or more second signal connectors 120, and first and second ground and power connectors remain electronically coupled to each other respectively until the first component 102 is twisted at the angle a2.

In example embodiments, 10°≤a2≤180°. In example embodiments, 20°≤a2≤90°. In example embodiments, 30°≤a2≤90°. In example embodiments, 40°≤a2≤90°. In example embodiments, 60°≤a2≤90°. In example embodiments, 30°≤a2≤80°. In example embodiments, 30°≤a2≤70°. In example embodiments, 30°≤a2≤60°. In example embodiments, 30°≤a2≤50°. In example embodiments, a2 is about 20°. In example embodiments, a2 is about 30°. In example embodiments, a2 is about 40°. In example embodiments, a2 is about 50°. In example embodiments, a2 is about 60°. In example embodiments, a2 is about 70°. In example embodiments, a2 is about 80°. In example embodiments, a2 is about 90°.

In various embodiments, the first component 102 is configured to attach to the second component by an insertion and a twist motion. In various embodiments the first power connector 116 electronically couples to the second power connector 126 or the first ground connector 118 electronically couples to the second ground connector 128 during the insertion, and the one or more first signal connectors 110 electronically couple to the one or more second signal connectors 120 during the twist motion.

In an example embodiment, the first and second power connectors 116 and 126 may be placed at the center of the first and second components 102 and 122 respectively, such that the first and second power connectors are electronically coupled when the first component 102 is sufficiently moved towards the second component 122 or is inserted in the second component 122. In an example embodiment, the first and second ground connectors 118 and 128 may instead be placed at the center of the first and second components 102 and 122 respectively, such that the ground connectors are electronically coupled when the first component 102 is sufficiently moved towards the second component 122 or is inserted in the second component 122.

Referring to FIG. 2(C), a schematic diagram illustrating various connectors of a sensor 100 in accordance with example embodiments of the present disclosure is provided. In various embodiments, when the first component 102 attaches to the second component 122, using the sliding motion for example in the direction 131, the first power connector 116 electronically couples to the second power connector 126 and the first ground connector 118 electronically couples to the second ground connector 128 before the one or more first signal connectors 110 electronically couple to the one or more second signal connectors 120.

In various embodiments, the first power connector 116 and the first ground connector 118 are placed closer to a first side boundary 251 of the first component 102 than the one or more first data connectors 110. In various embodiments, the second power connector 126, the second ground connector 128, and the one or more second data connectors 120 are elongated in the direction 131 and are placed in approximately the center of the second component in the direction 131. It is noted that the shape of the connectors shown are examples and for illustration purposes.

The connectors may have any of circular, oval, square, rectangular, or any other geometrical shapes and/or combinations thereof.

In various embodiments, the first side boundary 251 of the first component 102 is approximately aligned with a second side boundary 252 of the second component 122 and is slid in the detection 131. In various embodiments, as the first component 102 is slid on the second component 122, the first power connector 116 electronically couples to the second power connector 126 and the first ground connector 118 electronically couples to the second ground connector 128 and they remain electronically coupled respectively, until the one or more first data connectors 110 are electronically coupled to the one or more second data connectors 120. In various embodiments, a plurality of first data connectors electronically couple to the corresponding plurality of second data connectors at the same time or in different times during the sliding motion. In various embodiments, the one or more lips 133 and the one or more grooves 135 guide sliding the first component 102 on the second component 122.

In various embodiments, the first component 102 is slid on the second component 122 until all the first connectors are electronically coupled to the corresponding second connectors. In various embodiments, the first component 102 is slid on the second component 122 until all the first connectors are electronically coupled to the corresponding second connectors and the first component 102 is locked with the second component 122.

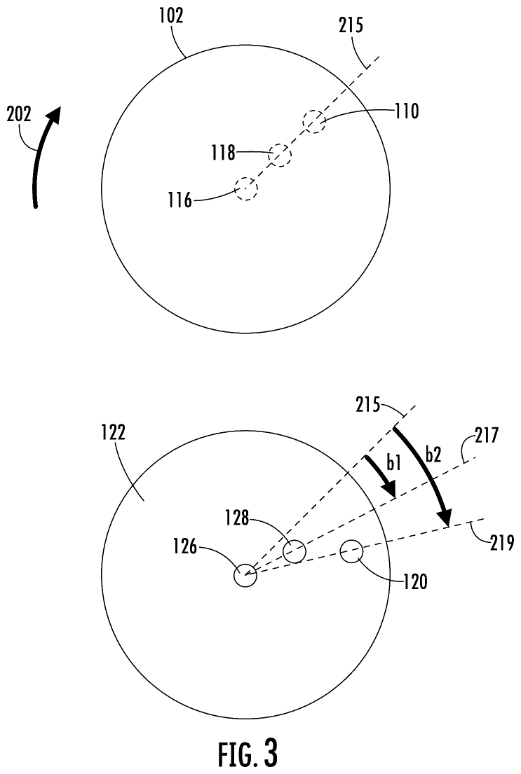

Referring to FIG. 3, a schematic diagram illustrating various connectors of a sensor 100 in accordance with example embodiments of the present disclosure is provided. In an example, the first power connector 116, the first ground connector 118, and the one or more first signal connectors 116 may be placed radially from the center point of the first component 102. In various embodiments, the first power connector 116, the first ground connector 118, and the one or more first signal connectors 110 may be placed on about the same radial angle, for example on a fourth radial axis 215. In an example embodiment, the first power connector 116 is located at the center of the first component 102. In an example embodiment, the first ground connector may instead be located at the center of the first component 102 (not shown).

In various embodiments, the second power connector 126, the second ground connector 128, and the one or more second signal connectors 120 are located radially from the center point of the second component 102 on the same or different radial angles. For example, the second ground connector 128 may be located at a radial angle b1 relative to the first ground connector 118 in the direction 202, for example on the fifth radial axis 217. In an example, the one or more second signal connectors 120 may be located at a radial angle b2 relative to the one or more first signal connectors 110 in the direction 202, for example on the sixth radial axis 219, where b2≥b1. In an example embodiment, when b1=b2 the second connectors are also located on the same radial angle.

In various embodiments in which the first and second power connectors 116 and 126 are placed at the center of the first and second components 102 and 122, when the first component 102 is inserted into the second component 122, the first power connector 116 electronically couples to the second power connector 126 before the first and second ground connectors or the one or more first and second signal connectors are electrically coupled to each other respectively.

In various embodiments, when the first component is twisted at the angle b1, the first ground connector 118 is electronically coupled to the second ground connector 128 before the one or more first and second signal connectors are electrically couple to each other. In example embodiments, the power is provided to the sensing element 106 by the time the first component 102 is twisted at the angle b1. In various embodiments, the first and second power and ground connectors include sizes and/or shapes such that the first and second power and ground connectors remain electronically coupled respectively and the power is provided to the sensing element 106 by the time the one or more first and second signal connectors 110 and 120 are electronically coupled to each other. In example embodiments, the first and second power and ground connectors may have elongated shapes, for example similar to the elongated shapes illustrated in FIG. 2(B).

In various embodiments, the first component 102 is twisted at the angle b2 and the one or more first and second signal connectors are electronically coupled by the time the first component 102 is twisted at the angle b2.

In example embodiments, 10°≤b2≤180°. In example embodiments, 20°≤b2≤90°. In example embodiments, 30°≤b2≤90°. In example embodiments, 40°≤b2≤90°. In example embodiments, 60°≤b2≤90°. In example embodiments, 30°≤b2≤80°. In example embodiments, 30°≤b2≤70°. In example embodiments, 30°≤b2≤60°. In example embodiments, 30°≤b2≤50°. In example embodiments, b2 is about 20°. In example embodiments, b2 is about 30°. In example embodiments, b2 is about 40°. In example embodiments, b2 is about 50°. In example embodiments, b2 is about 60°. In example embodiments, b2 is about 70°. In example embodiments, b2 is about 80°. In example embodiments, b2 is about 90°.

In various embodiment, when the first component is twisted at the angle b2, the one or more first signal connectors 110 are electronically coupled to the one or more second signal connectors 120. Example embodiments herein protect the sensing element 106 by providing power before establishing a signal connection with the sensing element 106, e.g., at the angle b2.

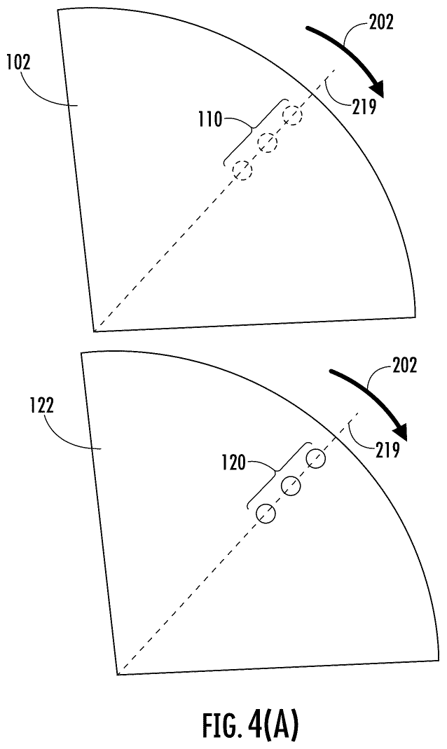

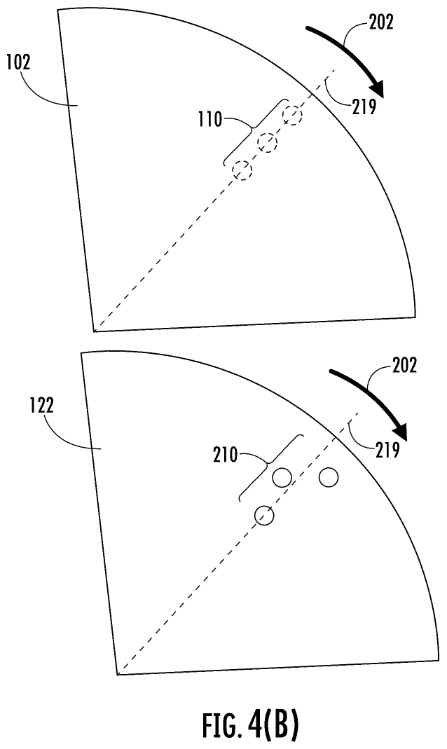

Referring to FIG. 4(A), a schematic diagram illustrating various signal connectors of a sensor 100 in accordance with example embodiments of the present disclosure is provided. In various embodiments, the one or more first signal connectors 110 are placed radially from the center point of the first component 102. In various embodiments, the one or more second signal connectors 120 are placed radially from the center point of the first component 122.

In various embodiments, each of the one or more signal connectors 110 electronically couple to the corresponding one or more second signal connectors 120 at different times during the attachment of the first component 102 to the second component 122. In example embodiments, when the first component 102 is twisted at a sufficient angle (e.g., angle b2), the one or more first signal connectors 110 electronically couple to the corresponding one or more second signal connectors 120 at various times.

In various embodiments, each of the one or more signal connectors 110 electronically couple to the corresponding one or more second signal connectors 120 at the same or at different times. Referring to FIG. 4(B), a schematic diagram illustrating various signal connectors of a sensor 100 in accordance with example embodiments of the present disclosure is provided. In various embodiments, the one or more first signal connectors 110 are placed radially from the center point of the first component 102. In various embodiments, the one or more second signal connectors 120 are placed radially from the center point of the first component 122, at different radial angles from the corresponding one or more first signal connectors 110.

In example embodiments, when the first component 102 is twisted at sufficient angles (e.g., angle b2 and/or greater), each of the one or more first signal connectors 110 electronically couple to the corresponding one or more second signal connectors 120 at their own corresponding angle and remain electronically coupled until the last first and second signal connectors electronically couple. It is noted that in various embodiments, the one or more second signal connectors may be placed at angles on the second component 122 such that a relative distance with the corresponding first signal connector is lessened. By placing the one or more first or second signal connectors at various angles, example embodiments provide for the one or more first and second signal connectors to electronically couple at the same or various times during the attachment of the first component 102 to the second component 122.

In various embodiments herein, using various placements of the one or more first signal connectors 110 and the one or more second signal connectors 120, a first subset of the one or more first signal connectors 110 electronically couple to a second subset of the one or more second signal connectors 120 before a rest of the one or more first signal connectors 110 electronically couple to a rest of the one or more second signal connectors 120.

In various embodiments, the first component 102 is configured to attach to the second component 102 by an insertion and a twist motion. In various embodiments, the first power connector electronically couples to the second power connector and the first ground connector electronically couples to the second ground connector during the insertion, and the one or more first signal connectors electronically couple to the one or more second signal connectors during the twist motion.

In various embodiments, the first and second power connectors 116 and 126 comprise first and second circular power bands. In various embodiments, the first and second ground connectors 118 and 128 comprise first and second circular ground bands. In example embodiments, the circular power bands or the circular ground bands may include any circular band comprising conductive material.

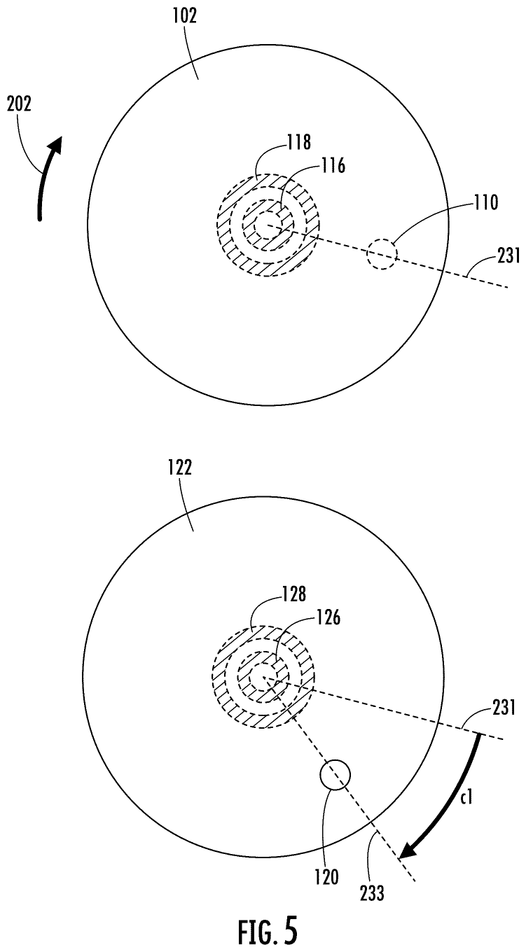

Referring to FIG. 5, a schematic diagram illustrating various connectors of a sensor 100 in accordance with example embodiments of the present disclosure is provided. In various embodiments, the first power connector 116 comprises a first circular power band centered on the first component 102. In various embodiments, the first ground connector 118 comprises a first circular ground band centered on the first component 102 and concentric with the first circular power band.

In various embodiments, the second power connector 126 comprises a second circular power band centered on the second component 122. In various embodiments, the second ground connector 128 comprises a second circular ground band centered on the second component 122 and concentric with the second circular power band.

In various embodiments, the one or more first signal connector 110 is placed on the first component 102 for example on a seventh radial axis 231. In various embodiments, the one or more second signal connectors 120 on the second component 122 may be placed at a relative radial angle c1 with respect to each other, for example on an eighth radial axis 233 as for example shown in FIG. 5.

In various embodiments, when the first component 102 is sufficiently moved towards the second component 122 or is inserted in the second component 122, the first circular power band is electronically coupled with the second circular power band and the first circular ground band is connected to the second circular ground band. In various embodiments, the first and second circular power bands and the first and second circular ground bands respectively remain electronically coupled to each other as the first component 102 is twisted with respect to the second component 122. In various embodiments, when the first component 102 is sufficiently twisted with respect to the second component 122, for example twisted at the angle c1, the one or more first signal connectors 110 are electronically coupled to the one or more second signal connectors 120.

In example embodiments, 10°≤c1≤180°. In example embodiments, 20°≤c1≤90°. In example embodiments, 30°≤c1≤90°. In example embodiments, 40°≤c1≤90°. In example embodiments, 60°≤c1≤90°. In example embodiments, 30°≤c1≤80°. In example embodiments, 30°≤c1≤70°. In example embodiments, 30°≤c1≤60°. In example embodiments, 30°≤c1≤50°. In example embodiments, c1 is about 20°. In example embodiments, c1 is about 30°. In example embodiments, c1 is about 40°. In example embodiments, c1 is about 50°. In example embodiments, c1 is about 60°. In example embodiments, c1 is about 70°. In example embodiments, c1 is about 80°. In example embodiments, c1 is about 90°.

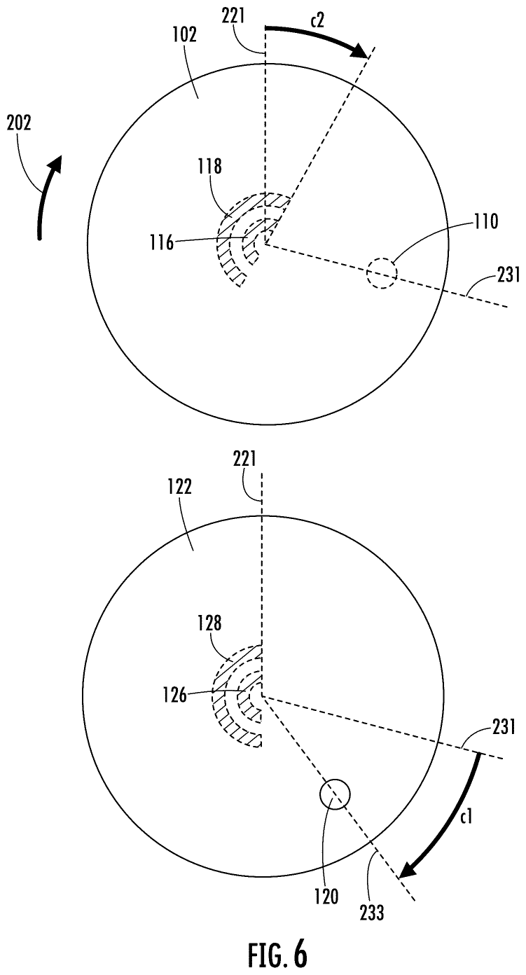

Referring to FIG. 6, a schematic diagram illustrating various connectors of a sensor 100 in accordance with example embodiments of the present disclosure is provided. In various embodiments, the first power connector 116 comprises a first partial circular power band centered on the first component 102. In various embodiments, the first ground connector 118 comprises a first partial circular ground band centered on the first component 102 and concentric with the first circular power band.

In various embodiments, the second power connector 126 comprises a second partial circular power band centered on the second component 122. In various embodiments, the second ground connector 128 comprises a second partial circular ground band centered on the second component 122 and concentric with the second partial circular power band 126. In various embodiments, the first partial circular power and ground bands are offset at a relative radial angel c2 with respect to the second partial circular power and ground bands as for example shown by FIG. 6. In various embodiments, the first partial circular power and ground bands may have the same length with or different lengths from the second partial circular power and ground bands respectively.

In various embodiments, the one or more first signal connector 110 on the first component 102 and the one or more second signal connectors 120 on the second component 122 may be at a relative radial angle c1 with respect to each other, as for example shown in FIG. 5. In example embodiments, c2=c1. In example embodiments, c2=0. In example embodiments, 0<c2<c1.

In various embodiments, when the first component 102 is sufficiently moved towards the second component 122 or is inserted in the second component 122, the first partial circular power band is electronically coupled to the second partial circular power band and the first partial circular ground band is electronically coupled to the second partial circular ground band. In various embodiments, the first and second partial circular power bands and the first and second partial circular ground bands respectively remain electronically coupled to each other as the first component 102 is twisted with respect to the second component 122. In various embodiments, when the first component 102 is sufficiently twisted with respect to the second component 122, for example twisted at the angle c1, the one or more first signal connectors 110 are electronically coupled to the one or more second signal connectors 120.

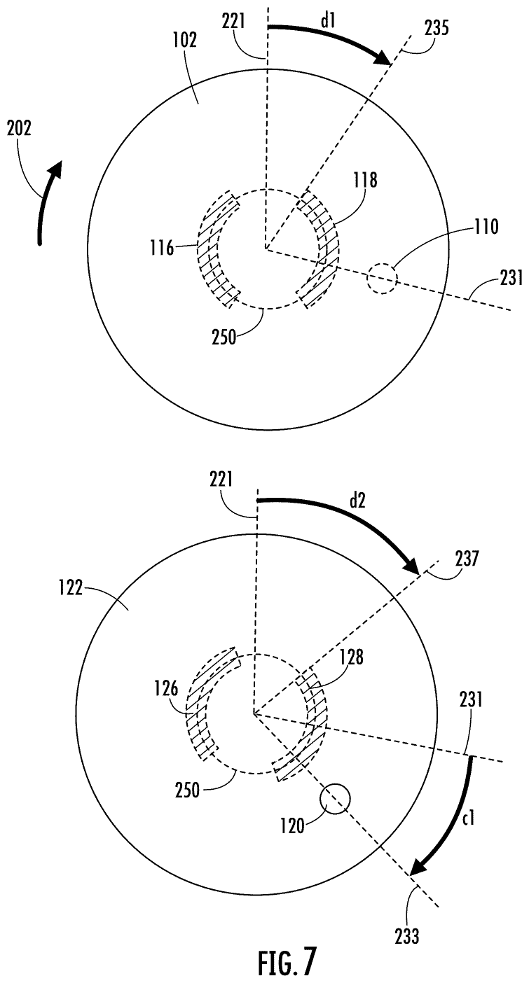

Referring to FIG. 7, a schematic diagram illustrating various connectors of a sensor 100 in accordance with example embodiments of the present disclosure is provided. In various embodiments, the first power connector 116 comprises a first partial circular power band centered on the first component 102. In various embodiments, the first ground connector 118 comprises a first partial circular ground band centered on the first component 102.

In various embodiments, the first partial circular power and ground bands are placed such that they are located on a trajectory of the same circular shape 250. In various embodiments, the first power and ground connectors are placed symmetrical with respect to the second radial axis 221. In various embodiments, the first power connector is placed such that a ninth radial axis 235 is offset from the second radial axis 221 with an angle d1.

In various embodiments, the second power connector 126 comprises a second partial circular power band centered on the second component 122. In various embodiments, the second ground connector 128 comprises a second partial circular ground band centered on the second component 122.

It is noted that in various embodiments (for example as illustrated in FIGS. 6, 7), being centered refers to a full circular trajectory, on which the partial circular shape is located, to be centered on the sensor component.

In various embodiments, the first partial circular power and ground bands are placed such that they are located on a trajectory of the same circular shape 250. In various embodiments, the second power and ground connectors are placed rotated relative to the first power and ground connectors such that a tenth radial axis 237 is offset from the second radial axis 221 with an angle d2. In example embodiments, d2≤2×d1. In example embodiments, d2<3×d1.

In example embodiments, the first partial circular power and ground bands have approximately the same length with the second partial circular power and ground bands respectively. In example embodiments, the first partial circular power and ground bands may have different lengths with the second partial circular power and ground bands respectively.

In various embodiments, the one or more first signal connector 110 on the first component 102 and the one or more second signal connectors 120 on the second component 122 may be at a relative radial angle c1 with respect to each other, as for example shown in FIG. 7. In example embodiments, c1=d2−d1.

In various embodiments, when the first component 102 is sufficiently moved towards the second component 122 or is inserted in the second component 122, the first partial circular power band is electronically coupled to the second partial circular power band and the first partial circular ground band is electronically coupled to the second partial circular ground band. In various embodiments, the first and second partial circular power bands and the first and second partial circular ground bands respectively remain electronically coupled to each other as the first component 102 is twisted with respect to the second component 122. In various embodiments, when the first component 102 is sufficiently twisted with respect to the second component 122, for example twisted at the angle c1, the one or more first signal connectors 110 are electronically coupled to the one or more second signal connectors 120. In various embodiments, when the first component 102 is sufficiently twisted with respect to the second component 122, for example twisted at the angle c1, the first power and ground connectors may approximately fully overlap with the corresponding second power and ground connectors.

In various embodiments, the first power, ground, and one or more signal connectors may be configured to slide over the corresponding second power, ground, and one or more signal connectors as the first component is twisted with respect to the second component. For example, any of the first or second power, ground or signal connectors may be pogo connectors. For example, the connectors may include any spring-loaded connectors. For example, the connectors may include any sliding connectors.

In various embodiments, the first component 102 is configured to attach to the second component 122 by an insertion and a twist motion. In various embodiments, the first power connector 116 electronically couples to the second power connector 126, the first ground connector 118 electronically couples to the second ground connector 128, and the one or more first signal connectors 110 electronically couple to the one or more second signal connectors 120 during the insertion.

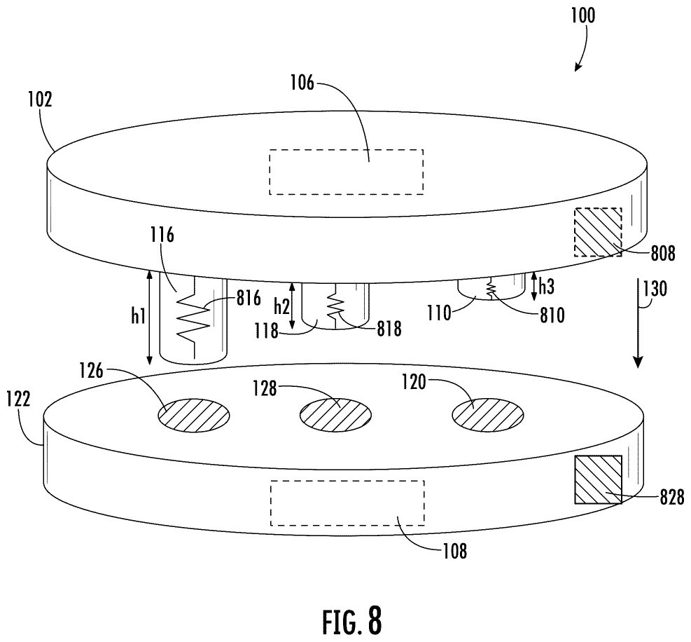

Referring to FIG. 8, a schematic diagram illustrating various connectors of a sensor 100 in accordance with example embodiments of the present disclosure is provided. In various embodiments, the first power connector 116 has a first adjustable height h1, the first ground connector 118 has a second adjustable height h2, and a signal connector 110 has a third adjustable height h3. In various embodiments, h1>h3 and h2>h3. In various embodiments, h1 and h2 may be the same or different. In various embodiments, h1 and h2 are adjustable. For example, h1 and h2 adjust as the first power connector 116 is pressed against the second power connector 126 and the first ground connector 118 is pressed against the second ground connector 128. In various embodiments h3 is adjustable.

In various embodiments, the power, ground, or signal connectors are spring loaded connectors. For example, the first power connector 116 may include a spring 816, the second ground connector may include a spring 818, and/or the first signal connector may include a spring 810. In various embodiments, the first and/or second power, ground and/or signal connectors may include or be made from height adjustable and/or flexible and/or bendable conductive material(s).

In various embodiments, as the first component 102 is inserted in the second component 122, the first power connector 116 electronically couples to the second power connector 126 and the first ground connector 118 electronically couples to the second ground connector 128, before the one or more signal connectors 110 electronically couple to the one or more second signal connector 120 because h1>h3 and h2>h3.

In example embodiments, the power, ground, and/or signal connectors may include any of the other shapes and forms as described herein, such as elongated, circular, partial circular, etc. In various embodiments, the height adjustable connectors may instead, and/or in addition be placed on the second component 122.

In example embodiments, after the first component 102 is inserted into the second component 122, the first component 102 is locked into the second component 122. In various embodiments, the first and second components include locking mechanisms 808 and 828 to lock the first component into the second component. In example embodiments, the locking mechanisms 808 and 828 include magnets or magnetic components configured to lock the first component into the second component. In example embodiments, the locking mechanisms 808 and 828 include latches or latching components configured to lock the first component into the second component.

In various embodiments, a twist motion is used to lock the first component into the second component.

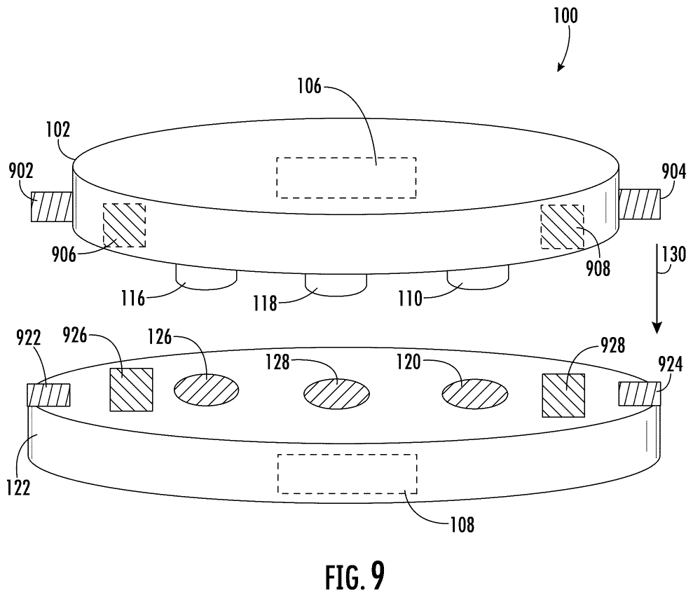

Referring to FIG. 9, a schematic diagram illustrating various connectors of a sensor 100 in accordance with example embodiments of the present disclosure is provided. In various embodiments, the first component 102 includes one or more tabs, for example a first tab 902 and a second tab 904. In example embodiments, the second component 122 includes one or more notches, for example a first notch 922 and a second notch 924. In various embodiments, the tabs and notches correspond to each other. In various embodiments, the one or more tabs and one or more notches are configured to guide the first component to be inserted into the second component, for example by fitting each tab into a corresponding notch. In various embodiments, the one or more tabs and notches guide the first component such that the correct first connectors electrically couple to the correct second connectors and in the correct order in accordance with various embodiments as described herein.

In various embodiments, the one or more tabs and the one or more notches are placed to prevent the one or more first signal connectors from electronically coupling to the one or more second signal connectors as the first component is inserted to the second component. For example, the tabs and notches are placed on the first or second components such that the first ground connector electronically couples to the second ground connector or the first power connector electronically couple to the second power connector as the first component is inserted into the second component, and before the one or more first signal connectors are electronically coupled to the one or more second signal connectors for example after a twist motion.

In various embodiments, the tabs and notches are placed on the first or second components such that the first ground connector electronically couples to the second ground connector or the first power connector electronically couple to the second power connector after the first component is interested in the second component and as the first component is twisted with respect to the second component before the one or more first signal connectors are electronically coupled to the one or more second signal connectors.

In various embodiments, first component may include the one or more notches and the second components comprise the one or more tabs, and the one or more tabs and one or more notches are configured to guide the first component to be inserted into the second component in accordance with various embodiments described herein.

In various embodiments, the first component is locked into the second components using mechanical locking mechanisms such as protrusions and depressions, or screw threads.

In various embodiments herein, the first component comprises one or more depressions, for example depressions 906 and 908, and the second components comprise one or more protrusions, for example protrusions 926 and 928. In example embodiments, corresponding protrusions and depressions are configured to lock the first component into the second component at an end of the insertion, and/or at the end of the twist motion. In various embodiments, the depressions may be on the second component and the protrusions may be on the first component.

In example embodiments, the first component is configured to detach from the second component. In example embodiments, the first component is configured to detach from the second component using a reverse twist motion. In various embodiments, using the various embodiments, examples and/or configurations described herein, during the reverse twist motion the one or more first and second signal connectors electronically decouple before the first and second power and ground connectors electronically decouple. In various embodiment, the one or more first and second signal connectors electronically decouple while the power is provided to the sensing element. In example embodiments, electronically decoupling the signal connectors while the sensing component is powered on may protect the electronic components and/or the circuitry of the sensing element.

In example embodiments, the first component is configured to detach from the second component using a pull motion in the reverse direction of the insertion. In various embodiment, using the various embodiments, examples and/or configurations described herein, during or before the pull motion, the one or more first and second signal connectors electronically decouple before the first and second power and ground connectors electronically decouple.

In example embodiments, the first component 102 may be attached to the second component 122 using one hand. For example, a user may be able to use any of the insert, twist, and/or sliding motion(s) to attach or detach the components by one hand. Therefore, example embodiments herein may increase the ease of use for the user and/or increase the convenience and/or speed of operation for a user of the sensor.

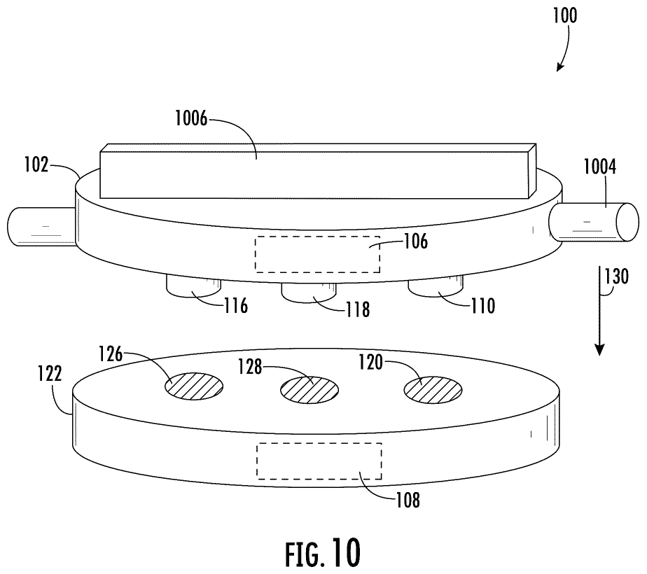

Referring to FIG. 10, a schematic diagram illustrating various connectors of a sensor 100 in accordance with example embodiments of the present disclosure is provided. In various embodiments, a tube 1004 passes through the first component 102. In various embodiments, the tube 1004 is configured to provide a flow of fluids through the first component 102. In various embodiments, the sensing element 106 is configured to sense various aspects of the flow of the fluids through the first component 102. For example, the sensing element 102 may sense any of flow rate, pressure, temperature, composition of the fluid, oxygen level, carbon dioxide level, and/or levels of other materials such as chemicals or particles, etc.

In various embodiments, power transmitted over the first and second power and ground connectors power on the sensing element 106 and enables sensing and/or generating sensing signal and/or data. In various embodiments, the sensing element 106 transmits sensing signal and/or data from the sensing element to the receiving circuitry via the first and second signal connectors.

In various embodiments, the first component 102 includes a handle 1006 configured to provide for convenient insertion of the first component 102 into the second component 122 and/or twisting of the fist component 102.

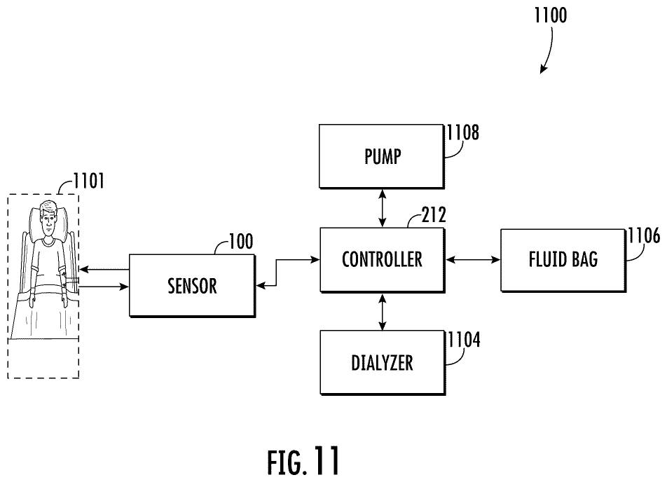

Referring to FIG. 11, a schematic diagram illustrating a dialysis system 1100 in accordance with example embodiments of the present disclosure is provided. In various embodiments, the dialysis system 1100 includes the sensor 100 to detect various parameters with respect to fluids (e.g., blood) from or to a patient 1101. In various embodiment, the sensor 100 is electronically coupled to a controller 212 configured to transmit control signal to and/or receive detection signal from the sensor 100. In various embodiment, using the detection signal received from the sensor 100 with respect to the patient fluids, the controller 212 controls operation of any of a pump 1108, dialyzer 1104, and/or a fluid bag 1106.

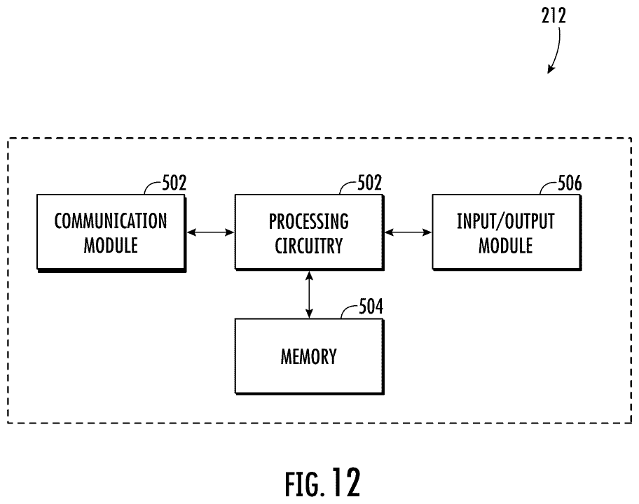

Referring now to FIG. 12, a schematic diagram depicting an example controller 212 of an example apparatus in electronic communication with various other components in accordance with various embodiments of the present disclosure is provided. For example, as described herein, the controller 212 may be in electronic communications with any of the sensor 100, pump 1108, dialyzer 1104, or fluid bag 1106. As shown, the controller 212 comprises processing circuitry 502, a communication module 508, input/output module 506, a memory 504 and/or other components configured to perform various operations, procedures, functions or the like described herein.

In various embodiments, referring to FIG. 11, the controller 212 (such as the processing circuitry 502, communication module 508, input/output module 506 and memory 504) is electrically coupled to and/or in electronic communication with the sensor 100, pump 1108, dialyzer 1104, or fluid bag 1106. In various embodiments, any of the sensor 100, pump 1108, dialyzer 1104, and/or fluid bag 1106 may exchange (e.g., transmit and receive) data with the processing circuitry 502 of the controller 212.

The processing circuitry 502 may be implemented as, for example, various devices comprising one or a plurality of microprocessors with accompanying digital signal processors; one or a plurality of processors without accompanying digital signal processors; one or a plurality of coprocessors; one or a plurality of multi-core processors; one or a plurality of controllers;

processing circuits; one or a plurality of computers; and various other processing elements (including integrated circuits, such as ASICs or FPGAs, or a certain combination thereof). In some embodiments, the processing circuitry 502 may comprise one or more processors. In one exemplary embodiment, the processing circuitry 502 is configured to execute instructions stored in the memory 504 or otherwise accessible by the processing circuitry 502. When executed by the processing circuitry 502, these instructions may enable the controller 212 to execute one or a plurality of the functions as described herein. No matter whether it is configured by hardware, firmware/software methods, or a combination thereof, the processing circuitry 502 may comprise entities capable of executing operations according to the embodiments of the present invention when correspondingly configured. Therefore, for example, when the processing circuitry 502 is implemented as an ASIC, an FPGA, or the like, the processing circuitry 502 may comprise specially configured hardware for implementing one or a plurality of operations described herein. Alternatively, as another example, when the processing circuitry 502 is implemented as an actuator of instructions (such as those that may be stored in the memory 504), the instructions may specifically configure the processing circuitry 502 to execute one or a plurality of methods, algorithms and operations described herein, such as those discussed with reference to any of the figures herein.

The memory 504 may comprise, for example, a volatile memory, a non-volatile memory, or a certain combination thereof. Although illustrated as a single memory in FIG. 12, the memory 504 may comprise a plurality of memory components. In various embodiments, the memory 504 may comprise, for example, a hard disk drive, a random access memory, a cache memory, a flash memory, a Compact Disc Read-Only Memory (CD-ROM), a Digital Versatile Disk Read-Only Memory (DVD-ROM), an optical disk, a circuit configured to store information, or a certain combination thereof. The memory 504 may be configured to store information, data, application programs, instructions, and etc., so that the controller 212 can execute various functions according to the embodiments of the present disclosure. For example, in at least some embodiments, the memory 504 is configured to cache input data for processing by the processing circuitry 502. Additionally or alternatively, in at least some embodiments, the memory 504 is configured to store program instructions for execution by the processing circuitry 502. The memory 504 may store information in the form of static and/or dynamic information. When the functions are executed, the stored information may be stored and/or used by the controller 212.

The communication module 508 may be implemented as any apparatus included in a circuit, hardware, a computer program product or a combination thereof, which is configured to receive and/or transmit data from/to another component or apparatus. The computer program product comprises computer-readable program instructions stored on a computer-readable medium (for example, the memory 504) and executed by a controller 212 (for example, the processing circuitry 502). In some embodiments, the communication module 508 (as with other components discussed herein) may be at least partially implemented as the processing circuitry 502 or otherwise controlled by the processing circuitry 502. In this regard, the communication module 508 may communicate with the processing circuitry 502, for example, through a bus. The communication module 508 may comprise, for example, antennas, transmitters, receivers, transceivers, network interface cards and/or supporting hardware and/or firmware/software, and is used for establishing communication with another apparatus. The communication module 508 may be configured to receive and/or transmit any data that may be stored by the memory 504 by using any protocol that can be used for communication between apparatuses. The communication module 508 may additionally or alternatively communicate with the memory 504, the input/output module 506 and/or any other component of the controller 212, for example, through a bus.

In some embodiments, the controller 212 may comprise an input/output module 506.

The input/output module 506 may communicate with the processing circuitry 502 to receive instructions input by the user and/or to provide audible, visual, mechanical or other outputs to the user. Therefore, the input/output module 506 may be in electronic communication with supporting devices, such as a keyboard, a mouse, a display, a touch screen display, and/or other input/output mechanisms. Alternatively, at least some aspects of the input/output module 506 may be implemented on a device used by the user to communicate with the controller 212. The input/output module 506 may communicate with the memory 504, the communication module 508 and/or any other component, for example, through a bus. One or a plurality of input/output modules and/or other components may be included in the controller 212.

In some examples, one or more of the procedures and/or methods described herein, for example for communicating with various components illustrated by FIG. 11, may be embodied by computer program instructions, which may be stored by a memory (such as a non-transitory memory) of a system employing an embodiment of the present disclosure and executed by a processing circuitry (such as a processor) of the system. These computer program instructions may direct the system to function in a particular manner, such that the instructions stored in the memory circuitry produce an article of manufacture, the execution of which implements the function specified in the flow diagram step/operation(s). Further, the system may comprise one or more other circuitries. Various circuitries of the system may be electronically coupled between and/or among each other to transmit and/or receive energy, data and/or information.

In some examples, embodiments may take the form of a computer program product on a non-transitory computer-readable storage medium storing computer-readable program instruction (e.g., computer software). Any suitable computer-readable storage medium may be utilized, including non-transitory hard disks, CD-ROMs, flash memory, optical storage devices, or magnetic storage devices.

Referring now to FIG. 13, a flowchart diagram illustrating example operations 1300, in accordance with various embodiments of the present disclosure are provided. In various embodiments, method 1300 provides assembling of a sensor. In various embodiments, assembling a sensor may include attaching a first component of a sensor to a second component of a sensor. In various embodiments, at step 1302, the method 1300 attaches a first component of the sensor to a second component of the sensor. In example embodiments, the first component is attached to the second component by a twist motion. For example, referring to FIG. 1(A), the first component 102 of the sensor 100 is attached to a second component 122 of the sensor 100.

In various embodiments, at step 1304, the method 1300 electronically couples a first power connector to a second power connector and a first ground connector to a second ground connector. For example, referring to FIG. 1(A) or FIG. 1(B), the first power connector 116 is electronically coupled to a second power connector 126 and a first ground connector 118 is electronically coupled to a second ground connector 128.

In various embodiments, at step 1306, the method 1300 electronically couples one or more first signal connectors to one or more second signal connectors. In various embodiments, the method 1300 electronically couples the first power connector to the second power connector and the first ground connector to the second ground connector before electronically coupling the first signal connector to the second signal connector. For example, referring to FIG. 1(A) or FIG. 1(B), the one or more first signal connectors 110 are electronically coupled to one or more second signal connector 120 after the first and second power and ground connectors are electronically coupled respectively. In various embodiments, the first power connector, the first ground connector, and the one or more first signal connectors are disposed on the first component and the second power connector, the second ground connector, and the one or more second signal connectors are disposed on a second component of the sensor.

In various embodiments, the first power connector is electronically coupled to the second power connector, and the first ground connector is electronically coupled to the second ground connector, and the one or more first signal connectors are electronically coupled to the one or more second signal connectors during the twist motion.

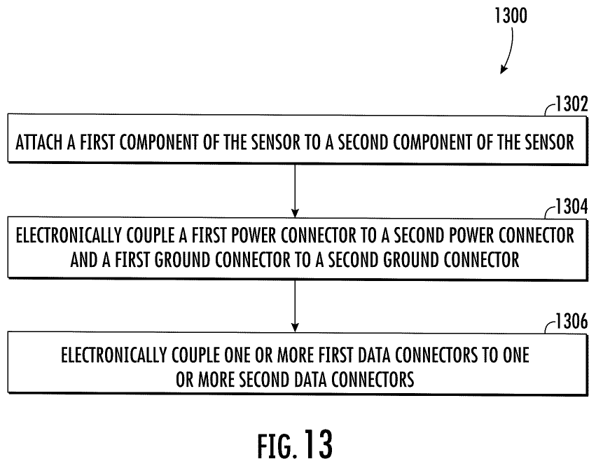

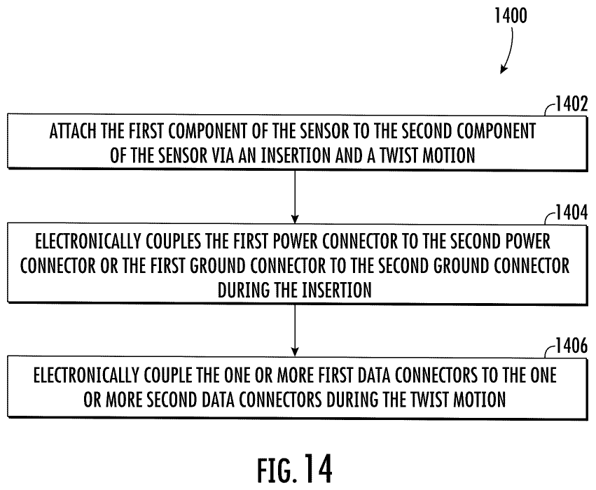

Referring now to FIG. 14, a flowchart diagram illustrating example operations 1400, in accordance with various embodiments of the present disclosure are provided. In various embodiments, at step 1402, the method 1400 attaches the first component of the sensor to the second component of the sensor by an insertion and a twist motion. For example, referring to FIG. 1(A) or FIG. 1(B), the first component 102 of the sensor 100 is attached to a second component 122 of the sensor 100 by an insertion and the twist motion.

In various embodiments, at step 1404, the method 1400 electronically couples the first power connector to the second power connector or the first ground connector to the second ground connector during the insertion. For example, referring to FIG. 3, the first power connector 116 is electronically coupled to the second power connector 126 during the insertion. In example embodiments where the first and second ground connectors 118 and 128 are placed at the center of the first and second components, the first and second ground connectors are coupled to each other during the insertion. For example, referring to FIGS. 5-7, the first and second power connectors 116 and 128, and/or the first and second ground connectors 118 and 128 are electronically coupled to each other during the insertion.

In various embodiments, at step 1406, the method 1400 electronically couples the one or more first signal connectors to the one or more second signal connectors during the twist motion. For example, referring to FIGS. 3-7, the one or more first signal connectors are electronically coupled to the one or more second signal connectors during the twist motion.

In various embodiments, electronically coupling the connectors may include sliding the first power connector on the second power connector, the first ground connector on the second ground connector, or the one or more first signal connectors over the one or more second signal connectors during the twist motion. In various embodiments, electronically coupling the connectors may include causing the first power connector touch the second power connector, and/or the first ground connector touch the second ground connector during the insertion.

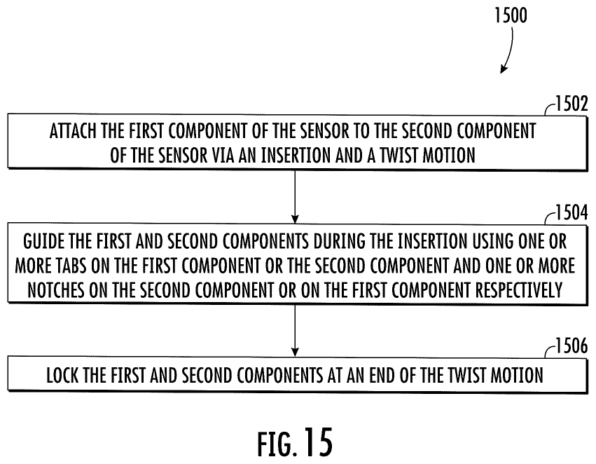

Referring now to FIG. 15, a flowchart diagram illustrating example operations 1500, in accordance with various embodiments of the present disclosure are provided. In various embodiments, at step 1502, the method 1500 attaches the first component of the sensor to the second component of the sensor by an insertion and the twist motion.

In various embodiments, at step 1504, the method 1500 guides the first and second components during the insertion using one or more tabs on the first component or the second component and one or more notches on the second component or on the first component respectively. For example, referring to FIG. 9, the method 1500 may guide the first component 102 when inserted into the second component 122, using the tabs 902 and 904 on the first component 102 and the corresponding notches 922 and 924 on the second component 122.

In various embodiments, at step 1506, the method 1500 locks the first and second components at an end of the twist motion. In example embodiments, the first and second components are locked using screw threads. In example embodiments, referring to FIG. 9, the first and second components are locked using depressions 906 and 908 and corresponding protrusions 926 and 928.

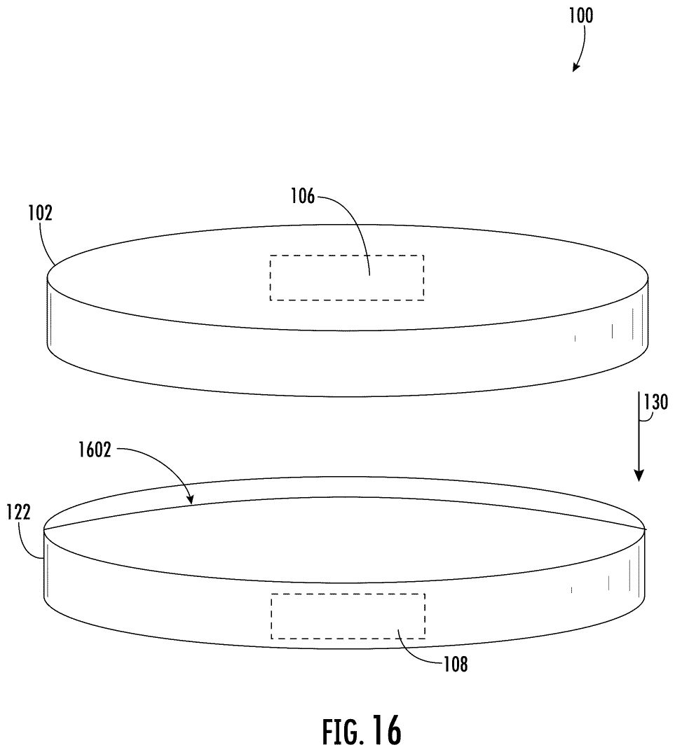

Referring now to FIG. 16, a schematic diagram illustrating various aspects of the sensor 100 in accordance with various embodiments of the present disclosure is provided. In various embodiments, the second component 122 includes a curved contour for a surface 1602 of the second component. In example embodiments, the curved contour may be any of a camber and/or hybrid profile. In example embodiments, the curved contour of the surface 1602 of the second component provides for shedding any fluid present and/or accumulated on it. For example, the curved contour provides for shedding the fluid by draining the fluid.

In various embodiments, the first component 102 is moved towards the second component 122 in the direction 130 and a force in the direction 130 is applied to the first component when attaching the first component 102 to the second component 122. In various embodiments, the force applied to the first component flattens the surface 1602 of the second component.

In various embodiments, the surface of the second component flattens when the first component attached to the second component. In various embodiments, the applied force at the direction 130 flattens the surface 1602 of the second component such that, with or without any additional twist motion, the corresponding connectors on the first and second components are electronically coupled as previously described with reference to FIGS. 1(A)-15. In example embodiments, when the first and second components are attached to each other, a fluid collection may occur on the surface 1602 of the second component. For example, the fluid collection may be due to condensation, leaked fluid from the first component 102, etc.

In various embodiments, the surface 1602 of the second component is flexible. For example, the surface 1602 of the second component is made from flexible and/or bendable material. For example, the surface 1602 of the second component may be made from any of PVC (polyvinyl chloride), PC Polycarbonate, and/or PP Polypropene, etc. In example embodiments, the surface 1602 of the second component may be made from any thermoplastics capable of being molded and/or remolded. In various embodiments, when the first component 102 is detached from the second component 122, the surface 1602 of the second component regains some or approximately all of its curved contour. In example embodiments, a regained curved contour of the surface 1602 of the second component sheds any fluid gathered on it, such as fluid accumulated on it during the time the first component 102 is attached to the second component 122. For example, the fluid is shed by draining from the regained curved contour.

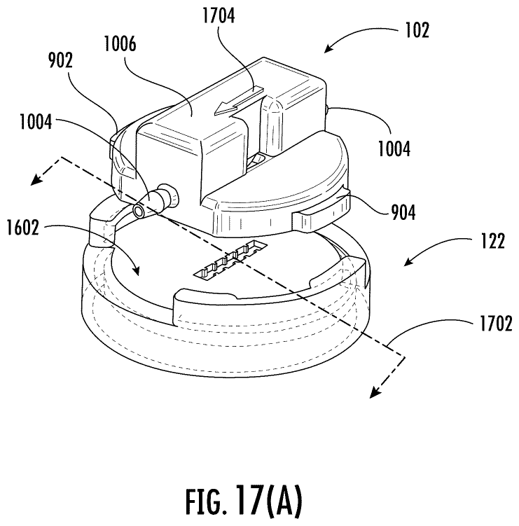

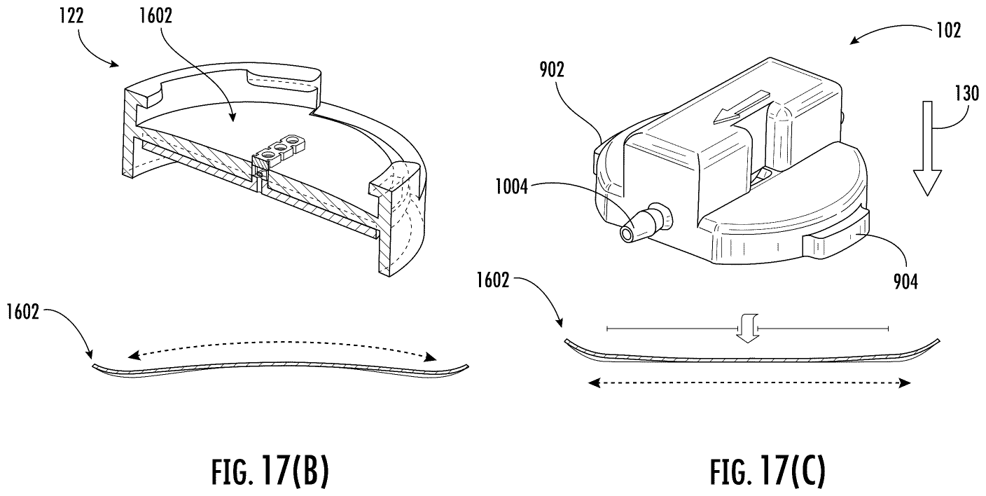

Referring now to FIG. 17(A), a schematic diagram illustrating various components of a sensor is illustrated in accordance with various embodiments of the present disclosure. In various embodiments, the first component 102 of the sensor includes the handle 1006. In various embodiments, the handle 1006 includes an arrow 1704 indicating a direction of a flow of fluids through the first component 102 for example passing through the tube 1004.

In various embodiments, the second component 122 includes the surface 1602 of the second component. In various embodiments, the surface 1602 of the second component includes a curved contour configured to shed fluid from the surface 1602 of the second component. In various embodiments, the first component 102 includes one or more tabs, for example a first tab 902 and a second tab 904. In example embodiments, the second component 122 includes one or more notches each corresponding to each of the one or tabs, as for example illustrated with reference to FIG. 9.

In various embodiments, the one or more tabs and one or more notches are configured to guide the first component to be inserted into the second component, for example by fitting each tab into a corresponding notch. In various embodiments, the one or more tabs and the one or more notches are configured to provide visual guidance for aligning the first component 102 in a correct position for insertion into and/or connecting to the second component 122. In various embodiments, any of the first component 102 and/or second component 122 include other visual guides for aligning the first and second components for insertion and/or attachment. For example, the visual indicators may indicate where to alight the first and second connectors for insertion. For example, the visual guides may show how far to twist the first component 102 with respect to the second component 122 to attach the first component with the second component. In example embodiments, the visual guides may include a marking, engraving, raised marking, etc.

In various embodiments, with reference to FIGS. 1-17(A), the first component may include a connection visual indicator indicating whether the corresponding connectors on the first and second components are electronically coupled. For example, a visual indicator may be a light source, such as a light emitting diode (LED) turning on or off and/or a display producing an output when the corresponding connectors are electronically coupled. In various embodiments, the visual indicator may indicate when any of the signal, power, and/or ground connectors are electronically coupled. For example, a first visual indicator may indicate when the corresponding signal connectors on the first and second components are electronically coupled. For example, a second visual indicator may indicate when any of or both of the corresponding power and ground connectors on the first and second components are electronically coupled. In various embodiments, the visual indicator(s) may be placed on any of the first component and/or second component.

Referring now to FIG. 17(B) a schematic diagram of the second component 122 depicting the cross section 1702 with reference to FIG. 17(A) is illustrated in accordance with various embodiments of the present disclosure. In various embodiments, the second component 122 includes a camber profile for the surface 1602 of the second component. Referring now to FIG. 17(C) a schematic diagram is provided illustrating the shape of the flexible second surface 1602 of the second component 122. In various embodiments, when the first component 102 is inserted in the second component 122 in the direction 130 or when pressed against the second component 122 in the direction 130, the shape of the flexible surface 1602 of the second component changes to a flat camber or a zero camber. In various embodiments, this change in shape when inserting or pressing the first component into the second component, allows the corresponding connections on the first and second components to electronically couple.

In various embodiments, when the first component 102 is disconnected and/or removed from the second component 122, the flexible surface 1602 of the second component returns to a camber profile. In example embodiments, the camber profile of the surface 1602 of the second component sheds or disposes of any and/or some of the fluid gathered on it, such as fluid accumulated on it during the time the first component 102 is attached to the second component 122. For example, the fluid is shed by draining from the sides of the camber profile.

In example embodiments, the curved contour avoids fluid collection on the surface 1602 of the second component when the first component 102 is not attached to the second component. For example, due to its curved contour (or the camber profile), any and/or some of the fluid gathered on the surface 1602 of the second component when the first and second components are not attached to each other, or when the surface 1602 of the second component holds or regains its curved contour shape, is shed, drained, and/or otherwise removed. Therefore, in example embodiments, the curved contour (or the camber profile) prevents accumulation of fluid on the surface 1602 of the second component.

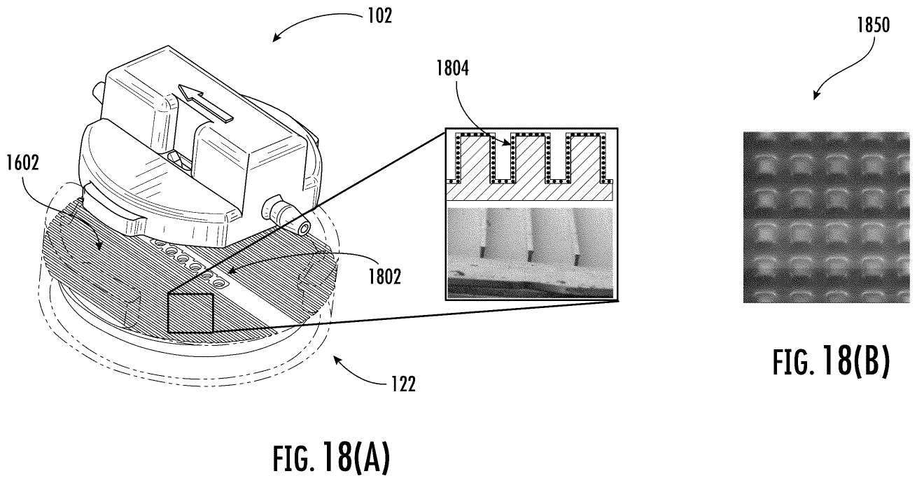

Referring now to FIG. 18(A), a schematic diagram illustrating various components of a sensor is illustrated in accordance with various embodiments of the present disclosure. In various embodiments, the surface 1602 of the second component 122 includes a hydrophobic material. In example embodiments, the hydrophobic material has low water adhesion and high mobility of water droplet, thus leading to a self-cleaning property. In example embodiments, the hydrophobic material is insoluble in water or other common fluids.

For example, the hydrophobic material may include any of epoxies, acrylics, polyethylene, polystyrene, polytetrafluorethylene, polyvinylchloride, polyesters, polydimethylsiloxane, and polyurethanes. In example embodiments, these and/or any other materials may be used as coatings, films, fibers, and/or in engineered plastics form. In example embodiments, a water contact angle or static water angle of the hydrophobic material is greater than approximately 90°, greater than approximately 100°, greater than approximately 110°, greater than approximately 120°, greater than approximately 130°, greater than approximately 140°, or greater than approximately 150°.

In various embodiments, the surface 1602 of the second component 122 includes a textured pattern, as for example illustrated in FIG. 18(A). In various embodiments, the textured pattern is configured to remove all or some of fluid from the surface of the second component by guiding the fluid off the surface of the second component. In example embodiments, the textured surface is made from the hydrophobic material assisting the fluid to be guided and/or removed away from the surface 1602 of the second component 122. In various embodiments, wherein the textured surface is made from a lubricant material assisting the fluid to be guided and/or removed away from the surface 1602 of the second component 122.

In various embodiments, the textured pattern includes one or more elongated parallel grooves configured to move the fluid off the surface of the second component as for example illustrated in the enlarged section of the surface 1602 of the second component 122 in FIG. 18(A).

In various embodiments, the grooves of the textured patterns of the surface 1602 are covered with any of the hydrophobic material and/or lubricant material layer 1804. In example embodiments, the lubricant material includes silicone.

In various embodiments, the textured pattern comprises one or more elongated intersecting grooves configured to move the fluid off the surface of the second component as for example illustrated in the schematic diagram in FIG. 18(B) illustrating intersecting pattern 1850 in accordance with various embodiments of the present disclosure.

In example embodiments, the textured pattern includes microtextured pattern. In example embodiments, the microtextured pattern includes nano/micro-grooves approximately 100-150 nm deep and spaced at approximately 700 nm. In example embodiments, the microtextured pattern includes nano/micro-grooves approximately 50-350 nm deep and spaced at approximately 50 nm-2 μm. In example embodiments, various other depth and spacing may be used which may depend on various cutting tools and/or surfacing processes used. In various embodiments, the textured or microtextured patterns acts as capillary to shed water or other fluid droplets. In example embodiments, the textured pattern is made from hydrophobic or superhydrophobic material and is covered with a lubricant layer. In example embodiments, the superhydrophobic surface has a static water contact angle above 150° and a contact angle hysteresis less than 5°. In example embodiments, the surface 1602 is a superhydrophobic surface with microtextured lubricant surface. In various embodiments, the surface 1602 is made using lithography and impregnating silicone lubricant in the textured pattern.

In various embodiments, the surface 1602 of the second component may include any and/or both the curved contour and the textured pattern. In various embodiments, any or both of the curved contour and the textured pattern may be configured move fluid away from the second surface 1602 and/or move fluid away from any of the second signal, power, and/or ground connections on the second component 122. In various embodiments, the second signal, power, and/or ground connections may be located in a connections area 1802 of the second component.

In example embodiments, the curved profile of the surface 1602 may guide fluid away from the connections area 1802. In various embodiments, grooves of the textured pattern of the surface 1602 may guide the fluid away from the connections area 1802. In example embodiments, by moving the fluids away from the second signal, power, and/or ground connectors, the connectors are protected from adverse effects of fluid such as short circuit, rust, etc.

In example embodiments, a sensor is provided that includes the first component 102, comprising a sensing element, a first power connector, a first ground connector, and one or more first signal connectors. In example embodiments, the sensor includes a second component including a receiving circuitry and a second power connector, a second ground connector, and one or more second signal connectors arranged on a surface 1602 of the second component. In various embodiments, the second power connector, a second ground connector, and one or more second signal connectors are placed in the connections area 1802 of the surface 1602.

In various embodiments, the surface of the second component includes a textured pattern configured to guide all or some of fluid away from the second power connector, the second ground connector, or the one or more second signal connectors arranged on the surface of the second component. For example, the textured pattern guides fluid in its capillaries away from the connectors area 1802. In example embodiments, guiding fluids away from the connectors protects the integrity of the connectors and or the electronic coupling with the corresponding first connectors.

In various embodiments, the surface of the second component comprises a lubricant in the textured pattern. In various embodiments, the surface of the second component comprises a hydrophobic material in the textured pattern. In various embodiments, a water contact angle of the hydrophobic material is greater than approximately 150°.

In various embodiments, the textured pattern includes one or more elongated parallel grooves configured to move the fluid away from the second power connector, the second ground connector, or the one or more second signal connectors arranged on the surface of the second component. In various embodiments, the textured pattern includes one or more elongated intersecting grooves configured to move the fluid away from the second power connector, the second ground connector, or the one or more second signal connectors arranged on the surface of the second component.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A sensor comprising:
a first component comprising:
a sensing element;
a first power connector and a first ground connector configured to provide power to the sensing element; and
one or more first signal connectors configured to transmit sensing signal from the sensing element; and
a second component comprising:
a receiving circuitry configured to receive the sensing signal;
a second power connector and a second ground connector configured to electronically couple to the first power connector and the first ground connector respectively; and
one or more second signal connectors configured to electronically couple to the corresponding one or more first signal connectors to transmit the sensing signal to the receiving circuitry,
wherein the first component is configured to attach to the second component, wherein when attaching the first component to the second component the first power connector electronically couples to the second power connector and the first ground connector electronically couples to the first ground connector before any of the one or more first signal connectors electronically couple to the corresponding one or more second signal connectors.

2. The sensor of claim 1, wherein the first component is configured to attach to the second component by a twist motion and wherein the first power connector electronically couples to the second power connector, the first ground connector electronically couples to the second ground connector, and the one or more first signal connectors electronically couple to the corresponding one or more second signal connectors during the twist motion.

3. The sensor of claim 1, wherein the first component is configured to attach to the second component by an insertion and a twist motion, wherein the first power connector electronically couples to the second power connector or the first ground connector electronically couples to the second ground connector during the insertion, and the one or more first signal connectors electronically couple to the corresponding one or more second signal connectors during the twist motion.

4. The sensor of claim 1, wherein the first component is configured to attach to the second component by an insertion and a twist motion, wherein the first power connector electronically couples to the second power connector, the first ground connector electronically couples to the second ground connector, and the one or more first signal connectors electronically couples to the corresponding one or more second signal connectors during the insertion.

5. The sensor of claim 1, wherein the first and second power connectors are configured to provide power from the second component to the sensing element and the one or more first and second signal connectors are configured to transmit the sensing signal from the sensing element to the receiving circuitry.

6. The sensor of claim 1, wherein the first and second power connectors comprise first and second circular power bands or the first and second ground connectors comprise first and second circular ground bands.

7. The sensor of claim 1, wherein the first component comprises one or more tabs and the second components comprise one or more notches, wherein the one or more tabs and one or more notches are configured to guide the first component to be inserted into the second component.

8. The sensor of claim 7, wherein the one or more tabs and the one or more notches are placed to prevent the one or more first signal connectors from electronically coupling to the corresponding one or more second signal connectors before the first and second power connectors are electronically coupled and the first and second ground connectors are electronically coupled.

9. The sensor of claim 1, wherein the first component is configured to attach to the second component using a twist motion, wherein the first component comprises one or more depressions and the second components comprise one or more protrusions, wherein the one or more protrusions and the one or more depressions are configured to lock the first component into the second component at an end of the twist motion.

10. The sensor of claim 1, wherein the first component is configured to attach to the second component using a twist motion and detach from the second component using a reverse twist motion.

11. The sensor of claim 1, wherein the first component is configured to attach to the second component using a sliding motion and detach from the second component using a reverse sliding motion.

12. The sensor of claim 1, wherein a first subset of the one or more first signal connectors electronically couple to a second subset of the one or more second signal connectors before a rest of the one or more first signal connectors electronically couple to a rest of the one or more second signal connectors.

13. A method for assembling a sensor, the method comprising:
attaching a first component of the sensor to a second component of the sensor; and
electronically coupling a first power connector to a second power connector and a first ground connector to a second ground connector before electronically coupling one or more first signal connectors to one or more second signal connectors,
wherein the first power connector, the first ground connector, and the one or more first signal connectors are disposed on the first component and the second power connector, the second ground connector, and the one or more second signal connectors are disposed on a second component.

14. The method for assembling the sensor according to claim 13, comprising:
attaching the first component of the sensor to the second component of the sensor by a twist motion; and
electronically coupling the first power connector to the second power connector, the first ground connector to the second ground connector, and the one or more first signal connectors to the one or more second signal connectors during the twist motion.

15. The method for assembling the sensor according to claim 13, comprising:
attaching the first component of the sensor to the second component of the sensor by an insertion and a twist motion;
electronically coupling the first power connector to the second power connector or the first ground connector to the second ground connector during the insertion; and
electronically coupling the one or more first signal connectors to the one or more second signal connectors during the twist motion.

16. A sensor comprising:
a first component comprising a sensing element, a first power connector, a first ground connector, and one or more first signal connectors; and
a second component comprising a receiving circuitry, a second power connector, a second ground connector, and one or more second signal connectors,
wherein the first and second components are configured to attach to and detach from each other and any of the first and second power connectors, the first and second ground connectors, and the one or more first and second signal connectors are configured such that when the first and second components are attached to each other the first and second power and the first and second ground connectors are electronically coupled before the one or more first and second signal connectors.

17. The sensor of claim 16, wherein the sensing element is configured to power on when the first and second power connectors are electronically coupled to each other and the first and second ground connectors are electronically coupled to each other.

18. The sensor of claim 17, wherein the one or more first and second signal connectors are configured to transmit sensing signal from the sensing element to the receiving circuitry when the one or more first and second signal connectors are electronically coupled to each other.

19. The sensor of claim 16, wherein the first component is configured to attach to the second component using any of an insertion, twist, and/or sliding motion and detach from the second component using any of a reverse insertion, twist, and/or sliding motion.

20. The sensor of claim 16, wherein a first subset of the one or more first signal connectors electronically couple to a second subset of the one or more second signal connectors before a rest of the one or more first signal connectors electronically couple to a rest of the one or more second signal connectors.
